(19) United States
(12) Patent Application Publication
(10) Pub. No.: US 2019/0304010 A1
(43) Pub. Date: Oct. 3, 2019

(54) INFORMATION PROCESSING DEVICE, NON-TRANSITORY STORAGE MEDIUM, AND INFORMATION PROCESSING METHOD

(71) Applicant: Toyota Jidosha Kabushiki Kaisha, Toyota-shi (JP)

(72) Inventors: Koichiro Mitsumaki, Nagoya-shi (JP); Masato Endo, Nagakute-shi (JP); Ryota Kondo, Nagoya-shi (JP); Yasuhisa Obata, Nagoya-shi (JP)

(73) Assignee: Toyota Jidosha Kabushiki Kaisha, Toyota-shi (JP)

(21) Appl. No.: 16/364,802

(22) Filed: Mar. 26, 2019

(30) Foreign Application Priority Data
Apr. 2, 2018 (JP) 2018-071139

(51) Int. Cl. G06Q 30/06

(52) U.S. Cl. CPC G06Q 30/0645; G06Q 30/0631

(57) ABSTRACT

An information processing device includes: a storage unit configured to store rental conditions of a vehicle presented by an owner of the vehicle and rental result information of the vehicle; an acquisition unit configured to acquire rental conditions and rental result information of the first vehicle from the storage unit; an analysis unit configured to extract rental result information of a second vehicle, the rental conditions of the first vehicle and rental conditions of the second vehicle being common in at least a part, compare and analyze the rental result information of the second vehicle and the rental result information of the first vehicle; a generation unit configured to generate, based on an analysis result, recommendation information on the rental conditions of the first vehicle for improving a rental result of the first vehicle; and an output unit configured to output the recommendation information.

### CROSS-REFERENCE TO RELATED APPLICATIONS

This application claims priority to Japanese Patent Application No. 2018-071139 filed on Apr. 2, 2018, which is incorporated herein by reference in its entirety including the specification, drawings and abstract.

### BACKGROUND

### 1. Technical Field

The disclosure relates to an information processing device, a non-transitory storage medium, and an information processing method.

### 2. Description of Related Art

Currently, so-called carsharing services that enable a plurality of users to share one vehicle are spreading. An owner performs owner registration in a carsharing service (hereinafter also referred to as a “CS service”) and then sets rental conditions of a vehicle (for example, a vehicle model, a region, and an available time period), and a user performs user registration in the CS service and then sets search conditions of a vehicle including a use application for a vehicle. In a system providing the CS service, when rental conditions of a vehicle from an owner and search conditions of a vehicle from a user match each other, the user's terminal is notified of information of matched vehicles (for example, see Japanese Unexamined Patent Application Publication No. 2008-52663 (JP 2008-52663 A)).

### SUMMARY

In such a system, when search conditions of a vehicle have been registered by a user once, a vehicle which the user wants to rent is automatically transmitted even when the user does not frequently access the system. Accordingly, the labor for searching for a vehicle is simplified and the user's burden is reduced. On the other hand, it is conceivable that an occupancy ratio of a vehicle can be further enhanced when the owner can ascertain efficient rental conditions of a vehicle in advance from the owner's viewpoint, but such a method has not been proposed.

The disclosure provides a technique capable of effectively utilizing a vehicle by notifying an owner of the vehicle of recommendation information on rental conditions for the vehicle for improving a rental result.

An information processing device according to a first aspect of the disclosure includes: an acquisition unit configured to acquire rental conditions of a first vehicle and rental result information of the first vehicle from the storage unit; an analysis unit configured to extract rental result information of a second vehicle, the rental conditions of the first vehicle and rental conditions of the second vehicle being common in at least a part, compare the rental result information of the second vehicle with the rental result information of the first vehicle, and analyze the rental result information of the second vehicle and the rental result information of the first vehicle; a generation unit configured to generate, based on an analysis result, recommendation information on the rental conditions of the first vehicle for improving a rental result of the first vehicle; and an output unit configured to output the recommendation information to a terminal of a first owner who owns the first vehicle.

A non-transitory storage medium according to a second aspect of the present disclosure stores a control program for a carsharing service. The control program causes a computer, which includes a storage unit configured to store rental conditions of an owner and rental result information in correlation for each vehicle, to perform: acquiring rental conditions of a first vehicle and rental result information of the first vehicle from the storage unit; extracting rental result information of a second vehicle, the rental conditions of the first vehicle and rental conditions of the second vehicle being common in at least a part; comparing the rental result information of the second vehicle with the rental result information of the first vehicle; analyzing the rental result information of the second vehicle and the rental result information of the first vehicle; generating, based on an analysis result, recommendation information on the rental conditions of the first vehicle for improving a rental result of the first vehicle; and outputting the recommendation information to a terminal of a first owner who owns the first vehicle.

An information processing method according to a third aspect of the present disclosure is performed by a computer which includes a storage unit configured to store rental conditions of an owner and rental result information in correlation for each other. The information processing method includes: extracting, by the computer, rental result information of a second vehicle, the rental conditions of the first vehicle and rental conditions of the second vehicle being common in at least a part; comparing, by the computer, the rental result information of the second vehicle with the rental result information of the first vehicle; analyzing, by the computer, the rental result information of the second vehicle and the rental result information of the first vehicle; generating, by the computer, recommendation information on the rental conditions of the first vehicle for improving a rental result of the first vehicle based on an analysis result; and outputting, by the computer, the recommendation information to a terminal of a first owner who owns the first vehicle.

According to the aspect of the disclosure, it is possible to provide a technique capable of effectively utilizing a vehicle by notifying an owner of the vehicle of recommendation information on rental conditions for the vehicle for improving a rental result.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of a carsharing system according to an embodiment;

FIG. 2 is a diagram illustrating an example of a configuration of functional blocks of an information processing device;

FIG. 3 is a diagram illustrating an example of a rental condition DB;

FIG. 4 is a diagram illustrating an example of a desired use condition DB;

FIG. 5 is a diagram illustrating an example of a rental result information DB;

FIG. 6 is a diagram illustrating an example of an owner use history information DB;

FIG. 7 is a diagram illustrating an example of a recommendation information DB; and

FIG. 8 is a diagram illustrating an example of a processing routine which is performed by the information processing device.

### DETAILED DESCRIPTION OF EMBODIMENTS

An embodiment of the disclosure will be described below with reference to the accompanying drawings. In the drawings, elements referred to by the same reference signs have the same or similar configurations.

### A. Embodiment

### <Basic Configuration of System>

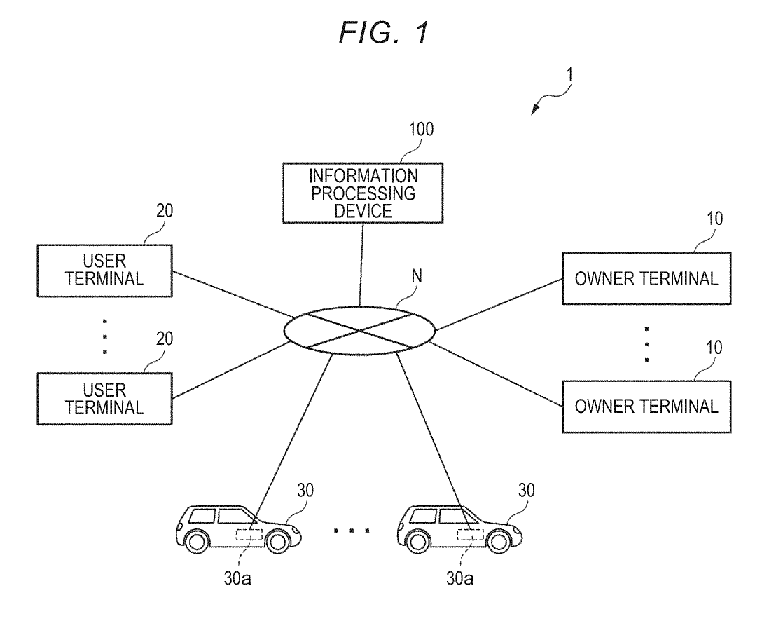

FIG. 1 is a diagram illustrating an example of a configuration of a carsharing system 1 according to an embodiment. The carsharing system 1 includes owner terminals 10, user terminals 20, vehicles 30, and an information processing device 100. An onboard unit 30a is mounted in each vehicle 30. The owner terminals 10, the user terminals 20, the onboard units 30a, and the information processing device 100 can communicate with each other via a communication network N.

### <Outline of CS Service>

A basic flow of a carsharing service (a CS service) will be described below. An owner (including a corporation and a person) who rents out a vehicle inputs basic information (such as name, sex, age, address, phone number, SNS account information, and deposit account) of the owner using an owner terminal 10 and performs owner registration. Thereafter, the owner sets rental conditions (which will be described later) of the vehicle using the owner terminal 10 and waits for a rental request from a user. On the other hand, a user who wants to rent a vehicle inputs basic information (such as name, sex, age, address, phone number, SNS account information, and credit card number) of the user using a user terminal 20 and performs user registration. Thereafter, the user sets desired use conditions of a vehicle (which will be described later) using the user terminal 20.

The information processing device 100 compares (checks) the desired use conditions of a vehicle set by the user with the rental conditions of a vehicle set by the owner and performs a matching process. When they match, the information processing device 100 notifies the owner and the user of information indicating that they match and information on a use procedure of rental of a vehicle (that is, a CS service). Thereafter, when the vehicle is actually rented, the information processing device 100 registers rental result information indicating a rental result for the owner.

The rental result information includes rental conditions when rental is actually performed, or the like. The information processing device 100 generates recommendation information on rental conditions for improving rental results by analyzing rental result information of vehicles which have been stored up to now (details of which will be described later) and notifies the owner terminals 10 of the owners of the generated recommendation information. The owners carry out correction of the rental conditions registered in the information processing device 100 or the like based on the recommendation information. Accordingly, the owners can improve rental results of vehicles and achieve effective utilization of the vehicles.

### <Device Configuration>

Each owner terminal 10 is a terminal which is used by an owner who rents a vehicle out and examples thereof include a smartphone, a tablet terminal, a wearable terminal, a mobile terminal, and a notebook PC. A screen for performing owner registration in a CS service or a screen for setting rental conditions of a vehicle is displayed on the owner terminal 10. An owner can perform an owner registration procedure, a vehicle rental procedure, and the like by inputting a variety of information to the screens.

Each user terminal 20 is a terminal which is used by a user who rents a vehicle and examples thereof include a smartphone, a tablet terminal, a wearable terminal, a mobile terminal, and a notebook PC. A screen for performing user registration in a CS service or a screen for setting desired use conditions of a vehicle is displayed on the user terminal 20. A user can perform a user registration procedure and a desired vehicle renting procedure by inputting a variety of information to the screens.

Each vehicle 30 is a vehicle which is provided for a CS service and is provided by each owner. The vehicles 30 include both a private vehicle (an owner of which is a person) and a vehicle which is owned by a company (an owner of which is a corporation). The vehicles 30 are not particularly limited as long as they are wheeled conveyances. Specifically, the vehicles 30 may be vehicles which are rented for carsharing by a company, may be taxies which can be shared, or may be vehicles which are owned by individual persons. The vehicles 30 are not limited to automobiles and may be large vehicles which can be boarded by several to several tens of persons such as buses or may be automatic two-wheeled vehicles or automatic three-wheeled vehicles. The vehicles 30 may be vehicles 30 which are driven with a steering wheel gripped by a user (hereinafter also referred to as a manually driven vehicle) or vehicles 30 which can be automatically driven (hereinafter also referred to as “automatically driven vehicles”).

Each onboard unit 30a is, for example, a car navigation device and can transmit and receive a variety of information to and from the information processing device 100. The onboard unit 30a periodically or randomly transmits use history information of the corresponding vehicle 30 of an owner (specifically, use date and times of the vehicle of the owner, traveling areas, and the like) to the information processing device 100. When a vehicle 30 is a manually driven vehicle, a return place which is designated by the owner of the vehicle 30 may be registered in the onboard unit 30a such as a car navigation device in advance. On the other hand, when the vehicle 30 is an automatically driven vehicle, control information for automatically driving the vehicle 30 to a designated place and the like in addition to information on the designated place which is transmitted from the information processing device 100 is transmitted to the onboard unit 30a.

As the premise for the CS service according to this embodiment, the information processing device 100 receives setting of rental conditions of vehicles 30 from owners in addition to owner registration or user registration and registers the received rental conditions in a database. The information processing device 100 also receives setting of desired use conditions of a vehicle 30 from a user and registers the received desired use conditions in the database. The information processing device 100 performs selection of a user who rents a vehicle 30 (that is, a matching process) by comparing (checking) the desired use conditions of a vehicle 30 set by the user with the rental conditions of the vehicles 30 set by the owners. When rental of a vehicle 30 is actually performed by an owner, the information processing device 100 registers rental result information indicating a rental result of the vehicle for the owner in the database. The information processing device 100 also registers use history information, which is periodically or randomly transmitted from the onboard units 30a and which indicates use histories of the vehicles 30 of the owners, in the database. The information processing device 100 generates recommendation information on rental conditions for improving the rental results by analyzing the rental result information of the vehicles stored up to now and transmits the generated recommendation information to the owner terminals 10. The information processing device 100 may be constituted by one or more information processing devices or may be constituted using a cloud server or a virtual server.

### <Functional Block Configuration>

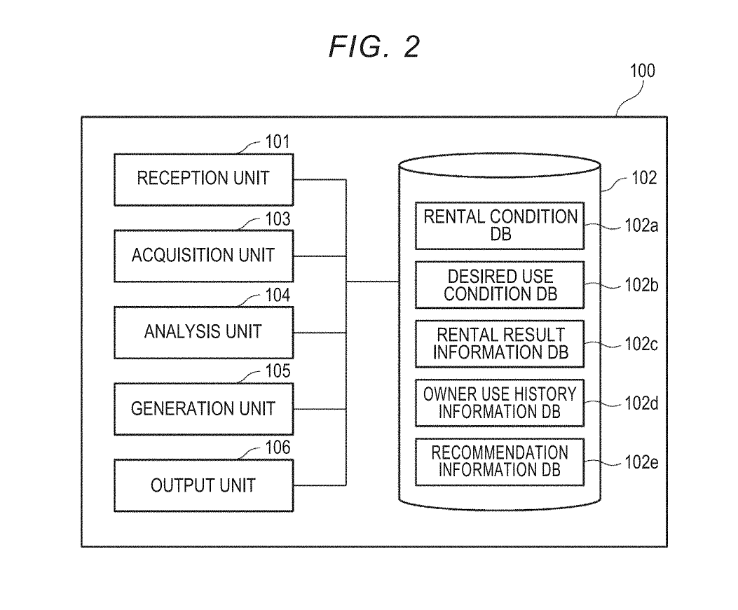

FIG. 2 is a diagram illustrating an example of a configuration of functional blocks of the information processing device 100. The information processing device 100 includes a reception unit 101, a storage unit 102, an acquisition unit 103, an analysis unit 104, a generation unit 105, and an output unit 106.

The reception unit 101, the acquisition unit 103, the analysis unit 104, the generation unit 105, and the output unit 106 can be embodied by causing a central processing unit (CPU) of the information processing device 100 to execute a program stored in the storage unit 102. The program can be stored in a recording medium. The recording medium in which the program is stored may be a non-transitory recording medium. The non-transitory recording medium is not particularly limited and may be a recording medium such as a USB memory or a CD-ROM. The storage unit 102 can be implemented using a memory or a storage device which is included in the information processing device 100.

The reception unit 101 receives setting of rental conditions of vehicles 30 from owners and stores the received rental conditions in the storage unit 102. The reception unit 101 receives setting of desired use conditions of vehicles 30 from users and stores the received desired use conditions in the storage unit 102.

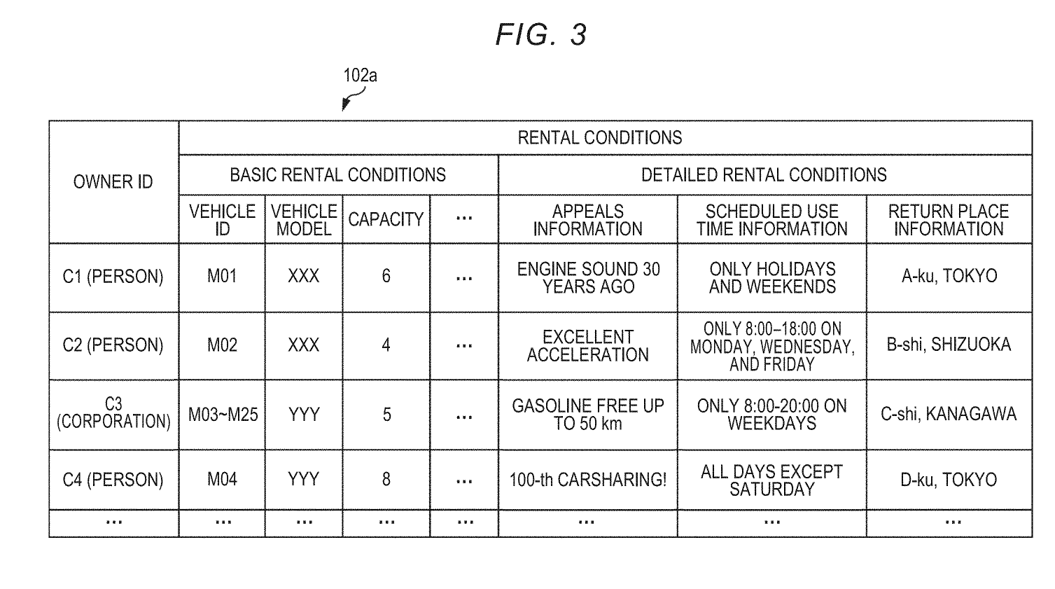

The storage unit 102 stores a rental condition database (DB) 102a, a desired use conditions database (DB) 102b, a rental result information database (DB) 102c, an owner use history information database (DB) 102d, and a recommendation information database (DB) 102e. Details registered in the DBs will be described below with reference to FIGS. 3 to 7.

<Rental Condition DB 102a>

FIG. 3 is a diagram illustrating an example of the rental condition DB 102a. As illustrated in FIG. 3, an owner ID (for example, a name of an owner) for uniquely identifying an owner and rental conditions are registered in the rental condition DB 102a in correlation with each other.

The rental conditions include basic rental conditions and detailed rental conditions. The basic rental conditions include at least a vehicle model. In FIG. 3, an example in which the basic rental conditions include a vehicle ID (for example, a vehicle number) for uniquely identifying a vehicle 30 and information indicating a vehicle model or a vehicle manufacturer and a boarding capacity is illustrated. The detailed rental conditions include appeals information, scheduled use time information, and return place information. The appeals information is information indicating conditions for a vehicle 30 of an owner (for example, “excellent acceleration”). The scheduled use time information is information indicating a use time of a vehicle 30 of an owner (that is, a time in which rental to a user is prohibited). The return place information is information indicating a return plate of a vehicle 30 which is designated by an owner.

In the example illustrated in FIG. 3, for example, an owner with an owner ID of “C1 (person)” sets a vehicle model “XXX” with a capacity of “six passengers” and with a vehicle ID of “M01” as the basic rental conditions and sets appeals information such as “with engine sound 30 years ago,” scheduled use time information such as being scheduled to use on “only holidays and weekends,” and return place information such as “A-ku, Tokyo” as the detailed rental conditions. The owner may set a home, a closest station, a parking lot around a home, or the like as the return place information and may also set another place (for example, a famous tourist site).

<Desired Use Condition DB 102b>

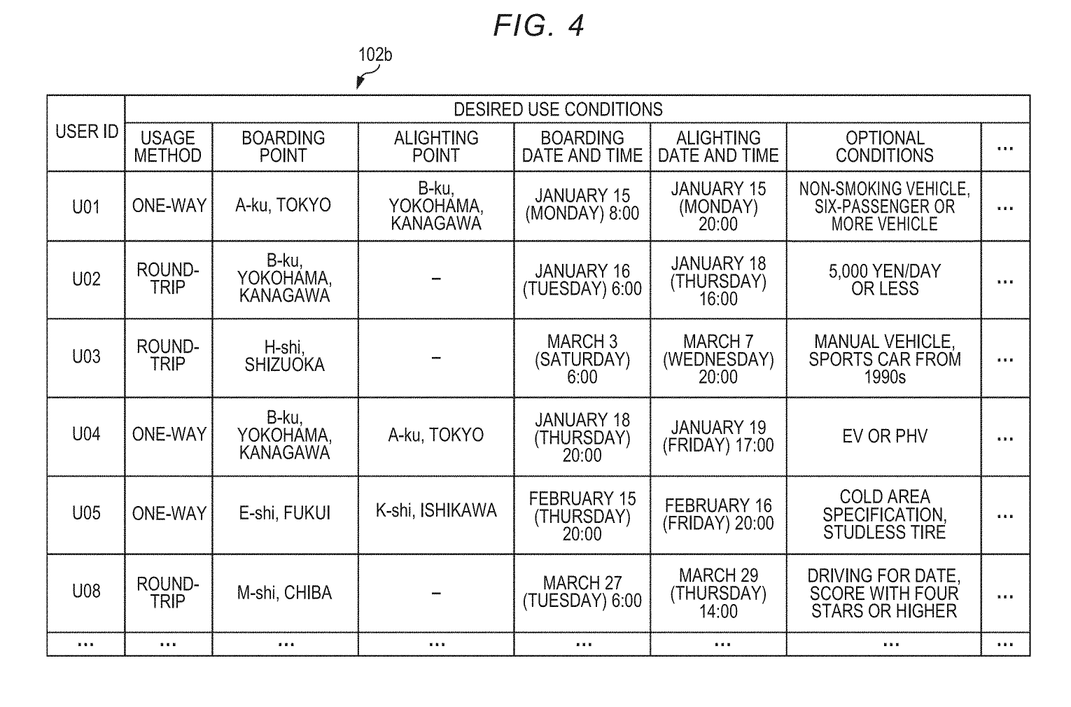

FIG. 4 is a diagram illustrating an example of the desired use condition DB 102b. As illustrated in FIG. 4, a user ID (for example, a user name) for uniquely identifying a user and desired use conditions are registered in the desired use condition DB 102b in correlation with each other. As the desired use conditions, a usage method for carsharing, a boarding point, an alighting point, a boarding date and time or an alighting date and time, optional conditions, and the like which are designated by a user are set. Specifically, one of round-trip carsharing or one-way carsharing is set as the usage method for carsharing, information (such as an address or latitude and longitude) indicating a point at which a user wants to board a vehicle 30 is set as the boarding point, and information (such as an address or latitude and longitude) indicating a point at which the user wants to alight from the vehicle 30 is set as the alighting point. A date and time at which the user wants to depart from the boarding point is set as the boarding date and time, and a date and time at which the user wants to arrive at the alighting point is set as the alighting date and time. In addition, optional conditions which are desired to be satisfied as far as possible when the user uses the CS service may be set.

In the example illustrated in FIG. 4, for example, a user with a user ID of “U01” sets desired use conditions indicating that the user wants to board a vehicle in “A-ku, Tokyo” at “January 15 (Monday) 8:00” and to alight from the vehicle in “B-ku, Yokohama, Kanagawa” at “January 15 (Monday) 20:00” (so-called “leave the vehicle” in this case) using “one-way” carsharing and the user wants a vehicle of “non-smoking” and “six-passengers or more.” A user with a user ID of “U02” sets desired use conditions indicating that the user wants to board a vehicle in “B-ku, Yokohama, Kanagawa” at “January 16 (Tuesday) 6:00” and to alight from the vehicle in the boarding place, that is, “B-ku, Yokohama, Kanagawa,” at “January 18 (Thursday) 16:00” using “round-trip” carsharing and the user wants a vehicle of “5,000 yen/day or less” as far as possible.

All or a part of a date and time may be omitted from the “boarding date and time” when a user does not want this. For example, a user can also set “there is no particular boarding time (a vehicle may depart at any time) as long as the user can board a vehicle in “Nagoya, Aichi” on “March 20.”

<Rental Result Information DB 102c>

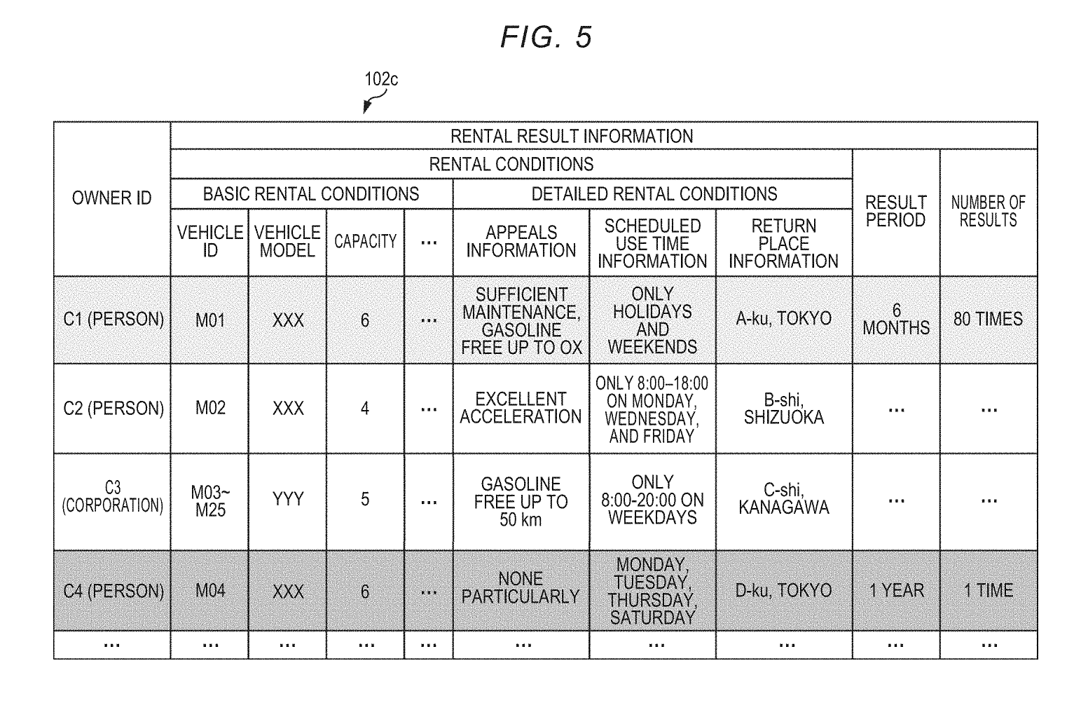

FIG. 5 is a diagram illustrating an example of the rental result information DB 102c. As illustrated in FIG. 5, an owner ID (for example, an owner name) for uniquely identifying an owner and rental result information are registered in the rental result information DB 102c in correlation with each other.

The rental result information includes rental conditions when rental of a vehicle 30 has been actually performed, a period (a result period) after owner registration has been performed, and the number of times of rental (the number of results) after owner registration has been performed. In the example illustrated in FIG. 5, for example, for an owner with an owner ID of “C1 (person),” it is stated that “6 months” has elapsed after owner registration has been performed and there is a rental result of “80 times” up to now under rental condition 1 which will be described below.

### (Rental Condition 1)

Basic rental conditions: Vehicle model “XXX” with a vehicle ID of “M01” and a capacity of “six passengers”

Detailed rental conditions: Appeals information of “sufficient maintenance, gasoline free up to OX,” scheduled use time information of being scheduled to be used on “only holidays and weekends,” return place information of “A-ku, Tokyo”

On the other hand, for an owner with an owner ID of “C4 (person),” it is stated that “1 year has elapsed after owner registration has been performed and there is a rental result of “1 time” up to now under rental condition 4 which will be described below.

### (Rental Condition 4)

Basic rental conditions: Vehicle model “XXX” with a vehicle ID of “M04” and a capacity of “six passengers”

Detailed rental conditions: Appeals information of “none particularly,” scheduled use time information of being scheduled to be used on “Monday, Tuesday, Thursday, and Saturday,” return place information of “A-ku, Tokyo”

<Owner Use History Information DB 102d>

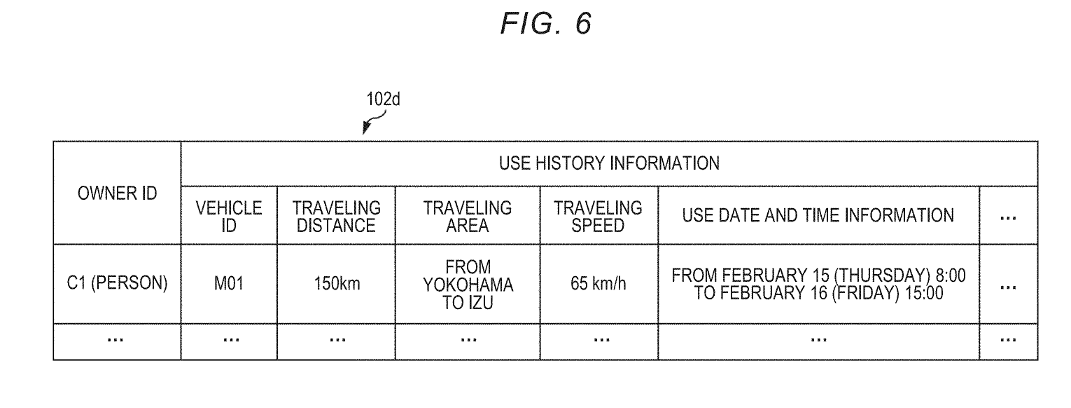

FIG. 6 is a diagram illustrating an example of the owner use history information DB 102d. As illustrated in FIG. 6, an owner D (for example, an owner name) for uniquely identifying an owner and use history information indicating a use history when the owner has actually used a vehicle 30 are registered in the owner use history information DB 102d in correlation with each other. The use history information is periodically or randomly transmitted from the onboard units 30a via the communication network N.

The use history information includes a vehicle ID, traveling information indicating a traveling distance, a traveling area, a traveling speed, and the like, and use date and time information indicating use date and times of the vehicle 30.

In the example illustrated in FIG. 6, for example, for an owner with an owner ID of “C1 (person),” traveling information indicating that a vehicle with a vehicle ID of “M01” has traveled “150 km” “from Yokohama” to “Izu” and an average speed at that time was “65 km/h” and use date and time information indicating that the vehicle 30 was used “from February 15 (Thursday) 8:00 to February 16 (Friday) 15:00” are registered as the use history information.

<Recommendation Information DB 102e>

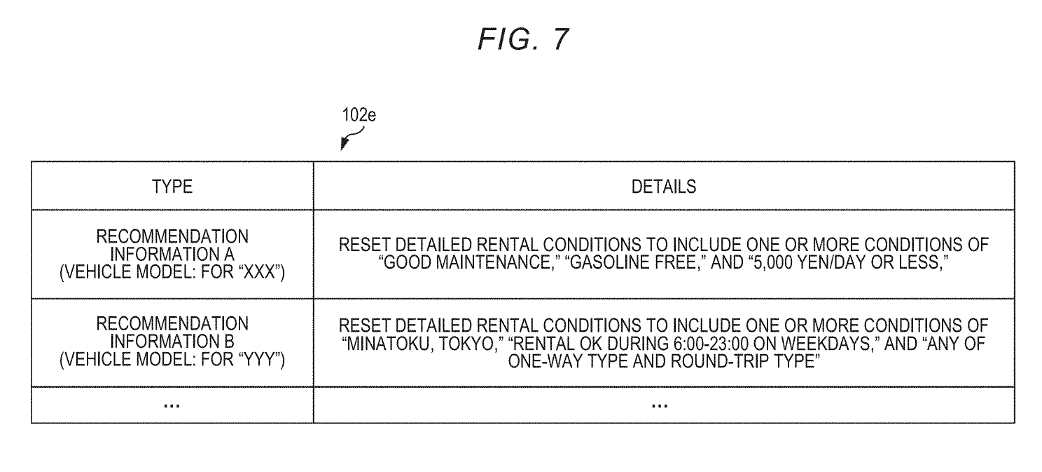

FIG. 7 is a diagram illustrating an example of the recommendation information DB 102e. As illustrated in FIG. 7, recommendation information on rental conditions for improving rental results is registered in the recommendation information DB 102e. The recommendation information is prepared based on analysis results of rental result information of vehicles stored up to now. In the example illustrated in FIG. 7, recommendation information A indicating that detailed rental conditions have to be reset to include one or more conditions of “good maintenance,” “gasoline free,” and “5,000 yen/day or less” is set for a vehicle with a vehicle model “XXX.” Recommendation information B indicating that detailed rental conditions have to be reset to include one or more conditions of “Minato-ku, Tokyo,” “rental OK during 6:00 to 23:00 on weekdays,” and “any of one-way type and round-trip type” is set for a vehicle with a vehicle model “YYY.”

The acquisition unit 103 acquires rental conditions and rental result information of a vehicle of a specific owner from the storage unit 102. A specific owner may be designated, for example, by the specific owner operating appropriately the owner terminal 10. The information processing device 100 may randomly designate a specific owner.

The analysis unit 104 searches the rental result information DB 102c using the rental conditions of the specific owner acquired by the acquisition unit 103 as a search key. As a result, the analysis unit 104 extracts rental result information of another owner who shares a part of basic rental conditions with the specific owner and who has a better rental result of a vehicle than the specific owner. Then, the analysis unit 104 compares and analyzes the extracted rental result information of the other owner and the rental result information of the specific owner acquired by the acquisition unit 103. In this embodiment, “vehicle model” (such as “XXX”) is assumed as the common part of the basic rental conditions and, for example, a combination of “capacity” (such as “six passengers”) and “vehicle model” (such as “XXX”) may be assumed.

The generation unit 105 generates recommendation information on rental conditions for improving the rental result of the vehicle of the specific owner based on the analysis result from the analysis unit 104.

The output unit 106 notifies the specific owner of the recommendation information on rental conditions generated by the generation unit 105. Notification of recommendation information is not limited to a specific owner and may be performed on all owners (or some owners) who share a part of basic rental conditions with the specific owner. In addition, recommendation information may be notified to owners who do not share a part of basic rental conditions with the specific owner as reference information.

A flow of comparison and analysis of rental result information of vehicles by the analysis unit 104, generation of recommendation information by the generation unit 105, and notification of recommendation information by the output unit 106 will be described below with reference to FIG. 5 and the like.

In the following description, it is assumed that an owner (with an owner ID of “C4 (person)”) is designated as a specific owner and an owner (with an owner ID of “C (person)”) is designated as another owner who is a comparison reference. For the specific owner (with an owner ID of “C4 (person)”), it is assumed that rental result information indicating that “1 year” has elapsed after owner registration has been performed and there is a rental result of “1 time” up to now under rental condition 4 which will be described below is registered (see FIG. 5).

### (Rental Condition 4)

Basic rental conditions: Vehicle model “XXX” with a vehicle ID of “M04” and a capacity of “six passengers”

Detailed rental conditions: Appeals information of “none particularly,” scheduled use time information of being scheduled to be used on “Monday, Tuesday, Thursday, and Saturday,” return place information of “A-ku, Tokyo”

On the other hand, for the other owner (with an owner ID of “C1 (person)”), it is assumed that rental result information indicating that “6 months” has elapsed after owner registration has been performed and there is a rental result of “80 times” up to now under rental condition 1 which will be described below is registered (see FIG. 5).

### (Rental Condition 1)

Basic rental conditions: Vehicle model “XXX” with a vehicle ID of “M01” and a capacity of “six passengers”

Detailed rental conditions: Appeals information of “sufficient maintenance, gasoline free up to OX,” scheduled use time information of being scheduled to be used on “only holidays and weekends,” return place information of “A-ku, Tokyo”

First, the analysis unit 104 extracts the vehicle model “XXX” which is included in a part of the rental conditions of the specific owner. Then, the analysis unit 104 extracts rental result information of the other owner who shares a part of basic rental conditions with the specific owner and who has a better rental result of a vehicle than the specific owner by searching the rental result information DB 102c using the vehicle model “XXX” as a search key. Here, the expression, “the rental result of the other owner is better than the rental result of the specific owner,” may mean that a ratio of the number of times the other owner has rented a vehicle to the period having elapsed after the other owner has performed owner registration is greater than a ratio of the number of times the specific owner has rented a vehicle to the period having elapsed after the specific owner has performed owner registration. In this embodiment, one owner with an owner ID of “C1 (person)” is extracted as the other owner, but a plurality of owners may be extracted. Then, the analysis unit 104 compares and analyzes rental result information 1 of the extracted other owner and rental result information 4 of the specific owner acquired by the acquisition unit 103 and outputs the analysis result to the generation unit 105.

Specifically, rental result information 1 of the other owner (with an owner ID of “C1 (person)”) includes appeals information of “good maintenance” and “gasoline free” as a part of detailed rental conditions, and rental result information 4 of the specific owner (with an owner ID of “C4 (person)”) includes only appeals information of “none particularly” as a part of detailed rental conditions. The analysis unit 104 outputs this analysis result to the generation unit 105. That is, the analysis result may indicate a difference between the rental conditions included in rental result information 1 of the other owner and the rental conditions included in rental result information 4 of the specific owner.

The generation unit 105 receives the analysis result supplied from the analysis unit 104, generates recommendation information indicating that detailed rental conditions have to be reset to include one or more conditions of “good maintenance” and “gasoline free” as the detailed rental conditions for the specific owner, and supplies the generated recommendation information to the output unit 106. The output unit 106 notifies the owner terminal 10 of the specific owner of the recommendation information on rental conditions supplied from the generation unit 105. The specific owner ascertains the recommendation information transmitted to the owner terminal 10 and corrects the settings of the detailed rental conditions or the like. Accordingly, the specific owner can improve the rental result of a vehicle and achieve effective utilization of the vehicle.

### <Process Routine>

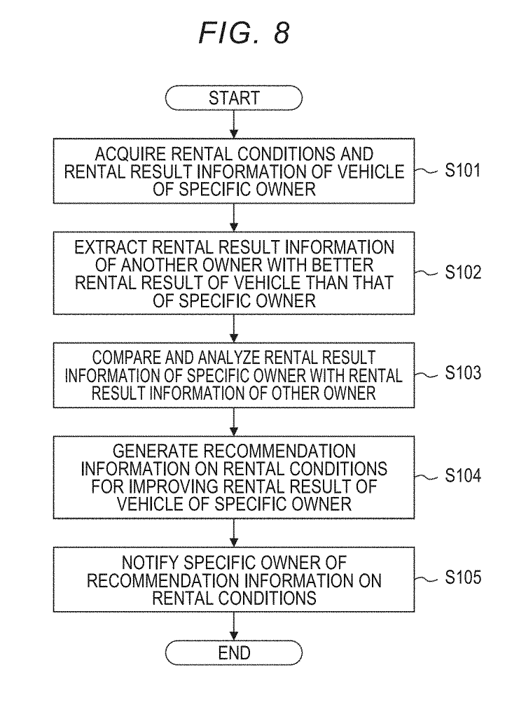

FIG. 8 is a diagram illustrating an example of a processing routine which is performed by the information processing device 100.

In Step S101, the acquisition unit 103 acquires rental conditions and rental result information of a vehicle of a designated specific owner from the storage unit 102. As described above, designation of a specific owner can be performed, for example, by causing the specific owner to appropriately operate the owner terminal 10, but the disclosure is not limited thereto.

In Step S102, the analysis unit 104 extracts rental result information of the other owner who shares a part of basic rental conditions and who has a better rental result of a vehicle than the specific owner by searching the rental result information DB 102c using the rental conditions of the specific owner acquired by the acquisition unit 103 as a search key.

In Step S103, the analysis unit 104 compares and analyzes the extracted rental result information of the other owner and the rental result information of the specific owner acquired by the acquisition unit 103. The specific comparison and analysis method has been described above in detail with reference to FIG. 5 and the like and thus description thereof will not be repeated herein.

In Step S104, the generation unit 105 generates recommendation information on rental conditions for improving the rental result of the vehicle of the specific owner based on the analysis result from the analysis unit 104.

In Step S105, the output unit 106 transmits the recommendation information on rental conditions generated by the generation unit 105 to the owner terminal 10 of the specific owner and ends the processing routine. As described above, transmission of recommendation information is not limited to the specific owner and may be performed for all owners (or some owners) who share a part of basic rental conditions with the specific owner. Each owner having received the recommendation information performs correction of rental conditions registered in the information processing device 100 or the like based on the recommendation information.

As described above, according to this embodiment, the information processing device 100 analyzes rental result information of owners stored up to now, generates recommendation information on rental conditions for improving rental results based on the analysis result, and transmits the generated recommendation information to owner terminals 10. Each owner performs correction of rental conditions registered in the information processing device 100 or the like based on the recommendation information. Accordingly, an owner can improve a rental result of a vehicle and achieve effective utilization of a vehicle.

### B. Modified Examples

The above-mentioned recommendation information is not limited to one type of information and may be a plurality of types of recommendation information. For example, a specific owner may not be able to respond to (may not want to respond to) first recommendation information including “gasoline free” as details. In this case, second recommendation information (for example, details such as “ridable together with a pet (except a large dog)”), third recommendation information (for example, details such as discount of 1,000 yen for a person who can return within 24 hours”), or the like may be transmitted to an owner terminal 10 to select other conditions as a next candidate. Although not specifically stated in the above-mentioned embodiment, recommendation information on rental conditions may be generated in consideration of a use result of a vehicle of an owner. Specifically, the acquisition unit 103 acquires use history information of a specific owner (see FIG. 6) in addition to rental conditions and rental result information of a vehicle of the specific owner from the storage unit 102. On the other hand, the generation unit 105 generates recommendation information on rental conditions in consideration of a use history (that is, use tendencies) of a vehicle of a specific owner by taking the use history information of the specific owner acquired by the acquisition unit 103 in addition to the analysis result from the analysis unit 104 into consideration.

For example, when a tendency that the specific owner “tends to use his or her vehicle on holidays” can be found from use date and time information included in the use history information, the generation unit 105 may generate recommendation information for improving the rental result at a date and time other than a date and time at which the specific owner is determined to use the vehicle such that usage of the specific owner is not hindered. Accordingly, the specific owner can achieve improvement of the rental result without changing his or her life pattern and the like (the number of times of use or the traveling area of the vehicle and the like). In other words, it is possible to curb a problem that a specific owner cannot use his or her vehicle as intended due to the specific owner having required excessive improvement of the rental result.

### C. Others

In this specification, “unit” does not simply refer to a physical structure and includes a case in which a process which is performed by the “unit” is embodied using software. A process which is performed by one “unit” or device may be implemented by two or more physical structures or devices or a process which is performed by two or more “units” or devices may be implemented by one physical structure or device.

In this specification, the order of steps of the above-mentioned processes can be arbitrarily changed or can be performed in parallel within a range in which inconsistency is not caused in processing details.

What is claimed is:

1. An information processing device comprising:
a storage unit configured to store rental conditions of a vehicle which are presented by an owner of the vehicle and rental result information of the vehicle in correlation with each other;
an acquisition unit configured to acquire rental conditions of a first vehicle and rental result information of the first vehicle from the storage unit;
an analysis unit configured to
extract rental result information of a second vehicle, the rental conditions of the first vehicle and rental conditions of the second vehicle being common in at least a part,
compare the rental result information of the second vehicle with the rental result information of the first vehicle, and
analyze the rental result information of the second vehicle and the rental result information of the first vehicle;
a generation unit configured to generate, based on an analysis result, recommendation information on the rental conditions of the first vehicle for improving a rental result of the first vehicle; and
an output unit configured to output the recommendation information to a terminal of a first owner who owns the first vehicle.

2. The information processing device according to claim 1, wherein:
the storage unit is configured to store the rental conditions, the rental result information, and use history information of the vehicle of the owner in correlation with each other,
the acquisition unit is configured to acquire first use history information which is the use history information of the first vehicle; and
the generation unit is configured to generate the recommendation information in consideration of a use tendency of the first vehicle based on the first use history information.

3. The information processing device according to claim 2, wherein:
the use history information includes use date-time information indicating a date and time at which the owner used the vehicle; and
the generation unit is configured to generate, based on the use date-time information included in the first use history information, the recommendation information for improving the rental result of the first vehicle on a date and time other than a date and time at which the first owner is expected to use the vehicle.

4. The information processing device according to claim 1, wherein the rental result information indicates a rental result associated with the number of times the vehicle has been rented.

5. The information processing device according to claim 4, wherein the rental result of the second vehicle is better than the rental result of the first vehicle.

6. The information processing device according to claim 1, wherein the analysis unit is configured to output a difference between the rental result information of the second vehicle and the rental result information of the first vehicle as the analysis result.

7. A non-transitory storage medium storing a control program for a carsharing service, the control program causing a computer, which includes a storage unit configured to store rental conditions of an owner and rental result information in correlation for each vehicle, to perform:
acquiring rental conditions of a first vehicle and rental result information of the first vehicle from the storage unit;
extracting rental result information of a second vehicle, the rental conditions of the first vehicle and rental conditions of the second vehicle being common in at least a part;
comparing the rental result information of the second vehicle with the rental result information of the first vehicle;
analyzing the rental result information of the second vehicle and the rental result information of the first vehicle;
generating, based on an analysis result, recommendation information on the rental conditions of the first vehicle for improving a rental result of the first vehicle; and
outputting the recommendation information to a terminal of a first owner who owns the first vehicle.

8. An information processing method performed by a computer which includes a storage unit configured to store rental conditions of an owner and rental result information in correlation for each vehicle, the processing method comprising:
acquiring, by the computer, rental conditions of a first vehicle and rental result information of the first vehicle from the storage unit;
extracting, by the computer, rental result information of a second vehicle, the rental conditions of the first vehicle and rental conditions of the second vehicle being common in at least a part;
comparing, by the computer, the rental result information of the second vehicle with the rental result information of the first vehicle;
analyzing, by the computer, the rental result information of the second vehicle and the rental result information of the first vehicle;
generating, by the computer, recommendation information on the rental conditions of the first vehicle for improving a rental result of the first vehicle based on an analysis result; and
outputting, by the computer, the recommendation information to a terminal of a first owner who owns the first vehicle.

9. The information processing method according to claim 8, wherein:
the storage unit is configured to store the rental conditions, the rental result information, and use history information of the vehicle of the owner in correlation with each other,
the step of acquiring includes acquiring first use history information which is the use history information of the first vehicle; and
the step of generating includes generating the recommendation information in consideration of a use tendency of the first vehicle based on the first use history information.

10. The information processing method according to claim 9, wherein:
the use history information includes use date-time information indicating a date and time at which the owner used the vehicle; and
the step of generating includes generating, based on the use date-time information included in the first use history information, the recommendation information for improving the rental result of the first vehicle on a date and time other than a date and time at which the first owner is expected to use the vehicle.

11. The information processing device according to claim 1, wherein:
the reception unit, the acquisition unit, the analysis unit, the generation unit, and the output unit are a central processing unit configured to execute a program stored in the storage unit.
